(19) United States
(12) Patent Application Publication
(10) Pub. No.: US 2015/0066877 A1
(43) Pub. Date: Mar. 5, 2015

(54) SEGMENT COMBINING FOR DEDUPLICATION

(71) Applicants: Mark D. Lillibridge, Mountain View, CA (US); Deepavali M. Bhagwat, Cupertino, CA (US)

(72) Inventors: Mark D. Lillibridge, Mountain View, CA (US); Deepavali M. Bhagwat, Cupertino, CA (US)

(21) Appl. No.: 14/395,492

(22) PCT Filed: May 1, 2012
(86) PCT No.: PCT/US2012/035916

§ 371 Date: Oct. 19, 2014

(51) Int. Cl. G06F 17/30

(52) U.S. Cl. CPC G06F 17/30159
USPC 707/692

(57) ABSTRACT

A non-transitory computer-readable storage device includes instructions that, when executed, cause one or more processors to receive a sequence of hashes. Next, the one or more processors are further caused to determine locations of previously stored copies of a subset of the data chunks corresponding to the hashes. The one or more processors are further caused to group hashes and corresponding data chunks into segments based in part on the determined information. The one or more processors are caused to choose, for each segment, a store to deduplicate that segment against. Finally, the one or more processors are further caused to combine two or more segments chosen to be deduplicated against the same store and deduplicate them as a whole using a second index.

### BACKGROUND

Administrators need to efficiently manage file servers and file server resources while keeping networks protected from unauthorized users yet accessible to authorized users. The practice of storing files on servers rather than locally on user's computers has led to identical data being stored more than once on the same system and even more than once on the same server.

Deduplication is a technique for eliminating redundant data, improving storage utilization, and reducing network traffic. Storage-based data deduplication is used to inspect large volumes of data and identify entire files, or large sections of files, that are identical in order to reduce the number of times that identical data is stored. For example, an email system may contain 100 instances of the same one-megabyte file attachment. Each time the email system is backed up, each of the 100 instances of the attachment is stored, requiring 100 megabytes of storage space. With data deduplication, only one instance of the attachment is stored, thus saving 99 megabytes of storage space.

Similarly, deduplication can be practiced at a much smaller scale, for example, on the order of kilobytes.

### BRIEF DESCRIPTION OF THE DRAWINGS

For a detailed description of exemplary embodiments of the invention, reference will now be made to the accompanying drawings in which:

FIG. 1A illustrates a logical system for segment combining;

FIG. 1B illustrates a hardware system for segment combining;

FIG. 2 illustrates a method for segment combining; and

FIG. 3 illustrates a storage device for segment combining.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical, or wireless electrical connection. Thus, if a first device couples to a second device, that connection may be through a direct electrical connection, through an indirect electrical connection via other devices and connections, through an optical electrical connection, through a wireless electrical connection, etc.

As used herein, the term “chunk” refers to a continuous subset of a data stream produced using a chunking algorithm.

As used herein, the term “segment” refers to a group of continuous chunks that is produced using a segmenting algorithm.

As used herein, the term “hash” refers to an identification of a chunk that is created using a hash function.

As used herein, the term “deduplicate” refers to the act of logically storing a chunk, segment, or other division of data in a storage system or at a storage node such that there is only one physical copy (or, in some cases, a few copies) of each unique chunk at the system or node. For example, deduplicating ABC, DBC, and EBF (where each letter represents a unique chunk) against an initially-empty storage node results in only one physical copy of B hut three logical copies. Specifically, if a chunk is deduplicated against a storage location and the chunk is not previously stored at the storage location, then the chunk is physically stored at the storage location. However, if the chunk is deduplicated against the storage location and the chunk is already stored at the storage location, then the chunk is not physically stored at the storage location again. In yet another example, if multiple chunks are deduplicated against the storage location and only some of the chunks are already stored at the storage location, then only the chunks not previously stored at the storage location are stored at the storage location during the deduplication.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

During chunk-based deduplication, unique chunks of data are each physically stored once no matter how many logical copies of them there may be. Subsequent chunks received may be compared to stored chunks, and if the comparison results in a match, the matching chunk is not physically stored again. Instead, the matching chunk may be replaced with a reference that points to the single physical copy of the chunk. Processes accessing the reference may be redirected to the single physical instance of the stored chunk. Using references in this way results in storage savings. Because identical chunks may occur many times throughout a system, the amount of data that must be stored in the system or transferred over the network is reduced.

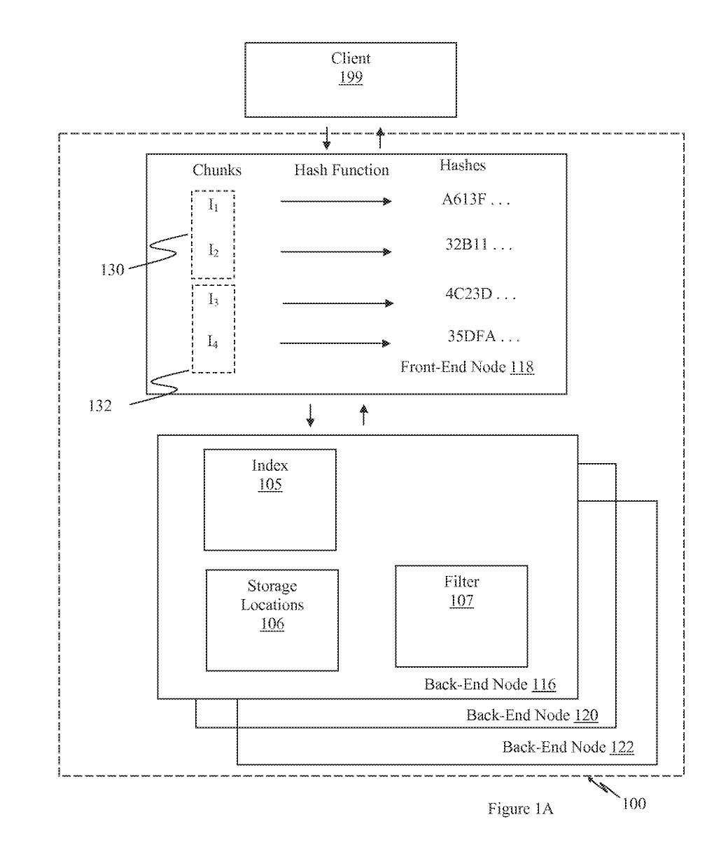

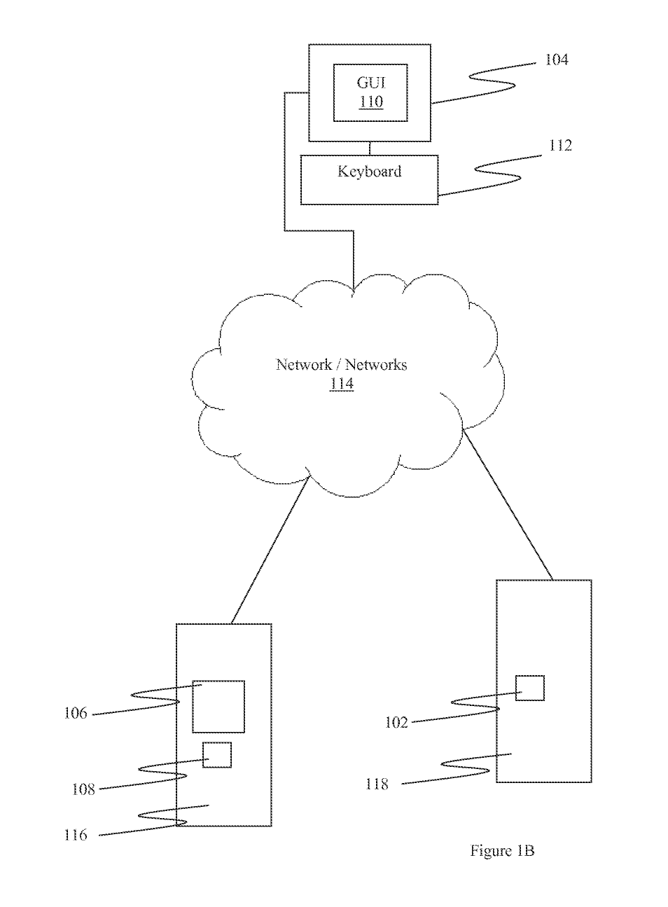

FIG. 1A illustrates a logical system 100 for segment combining. During deduplication, hashes of the chunks may be created in real time on a front end, which communicates with one or more deduplication back ends, or on a client 199. For example, the front end 118, which communicates with one or more back ends, which may be deduplication backend nodes 116, 120, 122. In various embodiments, front ends and back ends also include other computing devices or systems. A chunk of data is a continuous subset of a data stream that is produced using a chunking algorithm that may be based on size or logical file boundaries. Each chunk of data may be input to a hash function that may be cryptographic; e.g., MD5 or SHA1. In the example of FIG. 1A, chunks I₁, I₂, I₃, and I₄ result in hashes A613F . . . , 32B11 . . . , 4C23D . . . , and 35DFA . . . respectively. In at least some embodiments, each chunk may be approximately around 4 kilobytes, and each hash may be approximately 16 to 20 bytes.

Instead of chunks being compared for deduplication purposes, hashes of the chunks may be compared. Specifically, identical chunks will produce the same hash if the same hashing algorithm is used. Thus, if the hashes of two chunks are equal, and one chunk is already stored, the other chunk need not be physically stored again; this conserves storage space. Also, if the hashes are equal, underlying chunks themselves may be compared to verify duplication, or duplication may be assumed. Additionally, the system 100 may comprise one or more backend nodes 116, 120, 122. In at least one implementation, the different backend nodes 116, 120, 122 do not usually store the same chunks. As such, storage space is conserved because identical chunks are not stored between backend nodes 116, 120, 122, but segments (groups of chunks) must be routed to the correct backend node 116, 120, 122 to be effectively deduplicated.

Comparing hashes of chunks can be performed more efficiently than comparing the chunks themselves, especially when indexes and filters are used. To aid in the comparison process, indexes 105 and/or filters 107 may be used to determine which chunks are stored in which storage locations 106 on the backend nodes 116, 120, 122. The indexes 105 and/or filters 107 may reside on the backend nodes 116, 120, 122 in at least one implementation. In other implementations, the indexes 105, and/or filters 107 may be distributed among the front end nodes 118 and/or backend nodes 116, 120, 122 in any combination. Additionally, each backend node 116, 120, 122 may have separate indexes 105 and/or filters 107 because different data is stored on each backend node 116, 120, 122.

In some implementations, an index 105 comprises a data structure that maps hashes of chunks stored on that backend node to (possibly indirectly) the storage locations containing those chunks. This data structure may be a hash table. For a non-sparse index, an entry is created for every stored chunk. For a sparse index, an entry is created for only a limited fraction of the hashes of the chunks stored on that backend node. In at least one embodiment, the sparse index indexes only one out of every 64 chunks on average.

Filter 107 may be present and implemented as a Bloom filter in at least one embodiment. A Bloom filter is a space-efficient data structure for approximate set membership. That is, it represents a set but the represented set may contain elements not explicitly inserted. The filter 107 may represent the set of hashes of the set of chunks stored at that backend node. A backend node in this implementation can thus determine quickly if a given chunk could already be stored at that backend node by determining if its hash is a member of its filter 107.

Which backend node to deduplicate a chunk against (i.e., which backend node to route a chunk to) is not determined on a per chunk basis in at least one embodiment. Rather, routing is determined a segment (a continuous group of chunks) at a time. The input stream of data chunks may be partitioned into segments such that each data chunk belongs to exactly one segment. FIG. 1A illustrates that chunks I₁ and I₂ comprise segment 130, and that chunks I₃ and I₄ comprise segment 132. In other examples, segments may contain thousands of chunks. A segment may comprise a group of chunks that are adjacent.

Although FIG. 1A shows only one front end 118, systems may contain multiple front ends, each implementing similar functionality. Clients 199, of which only one is shown, may communicate with the same front end 118 for long periods of time. In one implementation, the functionality of front end 118 and the backend nodes 116, 120, 122 are combined in a single node.

FIG. 1B illustrates a hardware view of the system 100. Components of the system 100 may be distributed over a network or networks 114 in at least one embodiment. Specifically, a user may interact with GUI 110 and transmit commands and other information from an administrative console over the network 114 for processing by front-end node 118 and backend node 116. The display 104 may be a computer monitor, and a user may manipulate the GUI via the keyboard 112 and pointing device or computer mouse (not shown). The network 114 may comprise network elements such as switches, and may be the Internet in at least one embodiment. Front-end node 118 comprises a processor 102 that performs the hashing algorithm in at least one embodiment. In another embodiment, the system 100 comprises multiple front-end nodes. Backend node 116 comprises a processor 108 that may access the indexes 105 and/or filters 107, and the processor 108 may be coupled to storage locations 106. Many configurations and combinations of hardware components of the system 100 are possible. In at least one example, the system 100 comprises multiple back-end nodes.

One or more clients 199 are backed up periodically by scheduled command in at least one example. The virtual tape library (“VLT”) or network file system (“NFS”) protocols may be used as the protocol to back up a client 199.

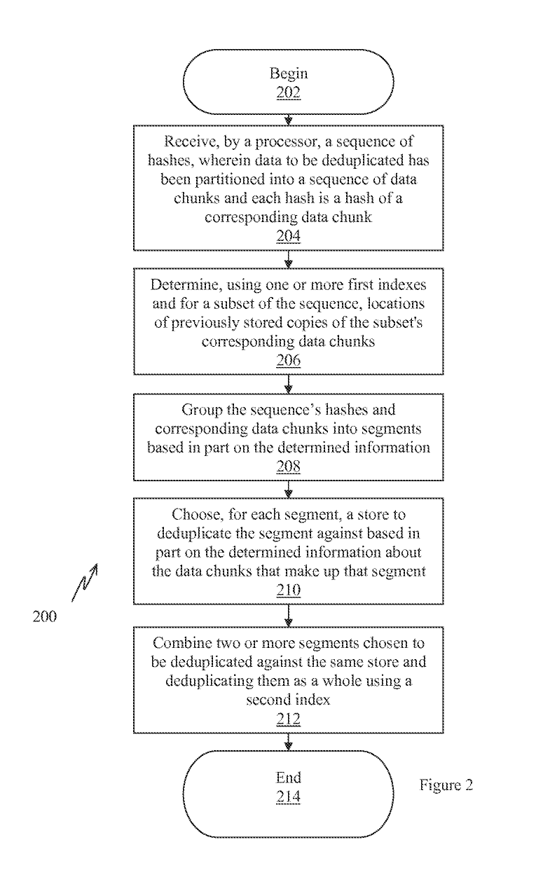

FIG. 2 illustrates a method for segment combining 200 beginning at 202 and ending at 214. At 204, a sequence of hashes is received. For example, the sequence may be generated by front-end node 118 from sequential chunks of data scheduled for deduplication. The sequential chunks of data may have been produced on front-end node 118 by chunking data received from client 199 for deduplication. The chunking process partitions the data into a sequence of data chunks. A sequence of hashes may in turn be generated by hashing each data chunk.

Alternatively, the chunking and hashing may be performed by the client 199, and only the hashes may be sent to the front-end node 118. Other variations are possible.

Each hash corresponds to a chunk. In at least one embodiment, the amount of chunks received is three times the length of an average segment.

At 206, for a subset of the sequence, locations of previously stored copies of the subset's corresponding data chunks are determined In some examples, the subset may be the entire sequence.

In at least one example, a query to the backends 116, 120, 122 is made for location information and the locations may be received as results of the query. In one implementation, the front-end node 118 may broadcast the subset of hashes to the backend nodes 116, 120, 122, each of which may then determine which of its locations 106 contain copies of the data chunks corresponding to the sent hashes and send the resulting location information back to front-end node 118.

For each data chunk, it may be determined which locations already contain copies of that data chunk. Heuristics may be used in at least one example. The locations may be as general as a group or cluster of backend nodes or a particular backend node, or the locations may be as specific as a chunk container (e.g., a file or disk portion that stores chunks) or other particular location on a specific backend node. The determined locations may be chunk containers, stores, or storage nodes.

Determining locations may comprise searching for one or more of the hashes in an index 105 such as a full chunk index or sparse chunk index, or testing to determine which of the hashes are members of a filter 107 such as a Bloom filter. For example, each backend node may test each received hash for membership in its Bloom filter 107 and return information indicating that it has copies of only the chunks corresponding to the hashes that are members of its Bloom filter 107.

The determined locations may be a group of backend nodes 116, 120, 122, a particular backend node 116, 120, 122, chunk containers, stores, or storage nodes. For example, each backend node may return a list of sets of chunk container identification numbers to the front-end node 118, each set pertaining to the corresponding hash/data chunk and the chunk container identification numbers identifying the chunk containers stored at the backend node in which copies of that data chunk are stored. These lists can be combined on the front-end node 118 into a single list that gives, for each data chunk, the chunk container ID/backend number pairs identifying chunk containers containing copies of that data chunk.

In another embodiment, the returned information identifies only which data chunks that backend node has copies for. Again, the information can be combined to produce a list giving, for each data chunk, the set of backend nodes containing copies of that data chunk.

At 208, the sequence's hashes and corresponding data chunks are grouped into segments based in part on the determined information. Specifically, hashes and chunks that have copies at the same backend or in the same store may be grouped.

Alternatively, in one implementation a breakpoint in the sequence of data chunks may be determined based on the locations, and the breakpoint may form a boundary of a segment of data chunks. Determining the break point may comprise determining regions in the sequence of data chunks based in part on which data chunks have copies in the same determined locations and determining a break point in the sequence of data chunks based on the regions. For each region there may be a location in which at least 90% of the data chunks with determined locations have previously stored copies.

Regions may be determined by finding the maximal, or largest, continuous subsequences such that each subsequence has an associated location and every data chunk in that subsequence either has that location as one of its determined locations or has no determined location. The regions may then be adjusted to remove overlap by shortening the parts of smaller regions that overlap the largest regions. This may involve discarding smaller regions that are entirely contained in larger regions.

Potential breakpoints may lie at the beginning and end of each of the remaining nonoverlapping larger regions. A potential breakpoint may be chosen as an actual breakpoint if it lies between a minimum segment size and a maximum segment size. If no such potential breakpoint exists, then a fallback method may be used such as using the maximum segment size or using another segmentation method that does not take determined locations into account.

Many other ways of grouping data chunks into segments using the determined locations are possible.

At 210, for each segment, a store to deduplicate the segment against is chosen based in part on the determined information about the data chunks that make up that segment. In one example, each backend node 116, 120, 122 implements a single store. In other examples, each backend node 116. 120, 122 may implement multiple stores, allowing rebalancing by moving stores between backend nodes when needed. For example, the determined information may comprise, for each data chunk associated with the subset of hashes, which stores already contain a copy of that data chunk. As such, choosing may include choosing for a given segment based in part on which stores the determined information indicates already have the most data chunks belonging to that segment.

At 212, two or more segments chosen to be deduplicated against the same store are combined. For example, the backend implementing the given store may concatenate two or more segments. The combined segments may be deduplicated as a whole using a second index. The second index may be a sparse index or a full chunk index. The second index may be one of the first indexes. Combining two or more segments may include combining a predetermined number of segments. Combining may also include concatenating segments together until a minimum size is reached.

Deduplicating as a whole means that the data of the combined segment is deduplicated in a single batch rather than in several batches or being grouped into batch(es) with other data.

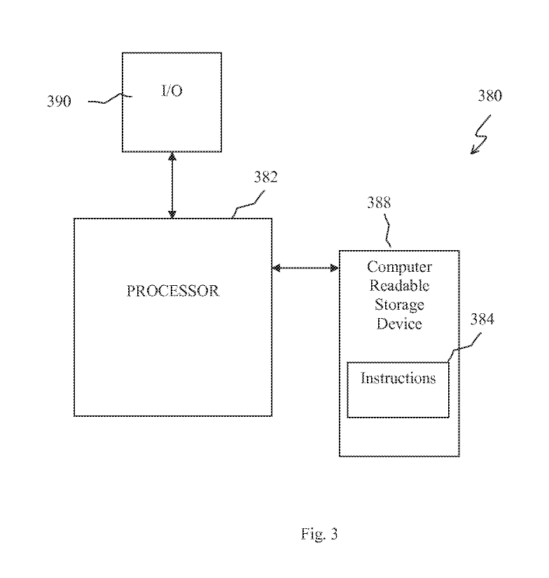

The system described above may be implemented on any particular machine or computer with sufficient processing power, memory resources, and throughput capability to handle the necessary workload placed upon the computer. FIG. 3 illustrates a particular computer system 380 suitable for implementing one or more examples disclosed herein. The computer system 380 includes one or more hardware processors 382 (which may be referred to as central processor units or CPUs) that are in communication with memory devices including computer-readable storage device 388 and input/output (I/O) 390 devices. The one or more processors may be implemented as one or more CPU chips.

In various embodiments, the computer-readable storage device 388 comprises a non-transitory storage device such as volatile memory (e.g., RAM), non-volatile storage (e.g., Flash memory, hard disk drive, CD ROM, etc.), or combinations thereof. The computer-readable storage device 388 may comprise a computer or machine-readable medium storing software or instructions 384 executed by the processor(s) 382. One or more of the actions described herein are performed by the processor(s) 382 during execution of the instructions 384.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A non-transitory computer-readable storage device comprising instructions that, when executed, cause one or more processors to:
receive a sequence of hashes, wherein data to be deduplicated has been partitioned into a sequence of data chunks and each hash is a hash of a corresponding data chunk;
determine, using one or more first indexes and for a subset of the sequence, locations of previously stored copies of the subset's corresponding data chunks;
group the sequence's hashes and corresponding data chunks into segments based in part on the determined information;
choose, for each segment, a store to deduplicate that segment against based in part on the determined information about the data chunks that make up that segment;
combine two or more segments chosen to be deduplicated against the same store and deduplicate them as a whole using a second index.

2. The device of claim 1, wherein the one or more first indexes are Bloom filters or sets.

3. The device of claim 1, wherein the second index is a sparse index.

4. The device of claim 1, wherein choosing causes the one or more processors to choose for a given segment based in part on which stores the determined information indicates already have the most data chunks belonging to that segment.

5. The device of claim 1, wherein combining causes the one or more processors to combine a predetermined number of segments.

6. The device of claim 1, wherein combining causes the one or more processors to concatenate segments together until a minimum size is reached.

7. A method, comprising:
receiving, by a processor, a sequence of hashes, wherein data to be deduplicated has been partitioned into a sequence of data chunks and each hash is a hash of a corresponding data chunk;
determining, using one or more first indexes and for a subset of the sequence, locations of previously stored copies of the subset's corresponding data chunks;
grouping the sequence's hashes and corresponding data chunks into segments based in part on the determined information;
choosing, for each segment, a store to deduplicate that segment against based in part on the determined information about the data chunks that make up that segment;
combining two or more segments chosen to be deduplicated against the same store and deduplicating them as a whole using a second index.

8. The method of claim 7, wherein the one or more first indexes are Bloom filters.

9. The method of claim 7, wherein the second index is a sparse index.

10. The method of claim 7, wherein choosing comprises choosing for a given segment based in part on which stores the determined information indicates already have the most data chunks belonging to that segment.

11. The method of claim 7, wherein combining two or more segments comprises combining a predetermined number of segments.

12. The method of claim 7, wherein combining two or more segments comprises concatenating segments together until a minimum size is reached.

13. A device comprising:
one or more processors;
memory coupled to the one or more processors;
the one or more processors to
receive a sequence of hashes, wherein data to be deduplicated has been partitioned into a sequence of data chunks and each hash is a hash of a corresponding data chunk;
determine, using one or more first indexes and for a subset of the sequence, locations of previously stored copies of the subset's corresponding data chunks;
group the sequence's hashes and corresponding data chunks into segments based in part on the determined information;
choose, for each segment, a store to deduplicate that segment against based in part on the determined information about the data chunks that make up that segment;
combine two or more segments chosen to be deduplicated against the same store and deduplicating them as a whole using a second index.

14. The device of claim 13, wherein choosing causes the one or more processors to choose for a given segment based in part on which stores the determined information indicates already have the most data chunks belonging to that segment.

15. The device of claim 13, wherein combining causes the one or more processors to concatenate segments together until a minimum size is reached.
